(19) United States
(12) Patent Application Publication
(10) Pub. No.: US 2012/0190524 A1
(43) Pub. Date: Jul. 26, 2012

(54) FOLDING APPARATUS AND METHOD

(75) Inventors: Tad T. Butterworth, Ashland, WI (US); Greg M. Kauppila, Ashland, WI (US)

(73) Assignee: C.G. Bretting Manufacturing Co., Inc., Ashland, WI (US)

(21) Appl. No.: 13/438,870

(22) Filed: Apr. 4, 2012

Related U.S. Application Data
(63) Continuation-in-part of application No. 12/977,393, filed on Dec. 23, 2010.

(51) Int. Cl. B31F 1/00

(52) U.S. Cl. 493/451

(57) ABSTRACT

Apparatuses and methods of forming discrete stacks of a plurality of zig-zag folded panels are provided. The apparatus and methods include defining a sheet to form all of the panels of the discrete stack of panels. The sheet may be defined by cutting the sheet from the web prior to folding the web into the interconnected panels for each sheet. The sheet may be defined by forming a separation line prior to folding the web into the interconnected panels for each sheet and then separating the sheet from the web of material at the separation line after the web of material is folded into the interconnected panels.

### CROSS-REFERENCE TO RELATED PATENT APPLICATIONS

This patent application is a continuation-in-part of co-pending U.S. patent application Ser. No. 12/977,393, filed Dec. 23, 2010, the entire teachings and disclosure of which are incorporated herein by reference thereto.

### FIELD OF THE INVENTION

This invention generally relates to methods and apparatus for folding a web of material to form a plurality of panels of the web of material.

### BACKGROUND OF THE INVENTION

In the past, paper towels for use in applications such as public restrooms were typically packaged in one of two basic forms. In one form, the individual sheets are cut and inter-folded such that they can be placed in a dispenser which allows an individual towel to be pulled from the bottom of the dispenser. The trailing end of one towel is typically interfolded with a portion of the leading end of the next sheet, so that as each sheet is pulled from the dispenser, a portion of the next sheet is left exposed to aid in pulling it from the dispenser.

In another approach, the towel material is wound continuously about a cardboard core to form a round roll of material or towels. The roll of towels is fed out of a dispenser having either manual or electrically actuated means for limiting the amount of toweling dispensed for an individual use, and severing the roll at a predetermined length of toweling.

Neither of these two previously-used approaches has been entirely satisfactory. With the folded towel approach, the cost of producing individual towels is higher than is desirable, and the folding or interfolding often results in voids within the stack of towels which reduce the effective capacity of the dispensers.

With the previously-used approach of winding a roll of towels around a core, the processing cost is reduced, but the utilization of volume within the towel dispenser is often poor due to the volume consumed by the towel core, as well as void spaces between adjacent round rolls, if the dispenser is designed to include such replacement rolls. Also, where the towel dispensers are serviced only periodically, a partially depleted roll of towels is often thrown out to preclude having the dispenser run out of toweling before the service attendant can return to replace a completely depleted roll.

In light of the above summarized limitations of prior designs, it is desirable to provide an improved folding apparatus and method for producing toweling for use in dispensers and applications such as public restrooms that does not have the limitations and expense of individual sheets or the inefficiencies associated with roll forms.

### BRIEF SUMMARY OF THE INVENTION

In one embodiment, a method for forming a single sheet into a zig-zag folded stack of panels of the web of material is provided. The method includes feeding the web of material to a pair of counter-rotating folding rolls of a folding apparatus. The counter-rotating rolls have a nip therebetween. The method includes folding the web of material into a plurality of zig-zag folded panels. The method also includes separating the web of material into sheets upstream of the nip between the pair of counter-rotating rolls. The method also includes forming each sheet into a discrete stack of a plurality of zig-zag folded panels.

In some embodiments of the method, separating the web of material into sheets includes cutting the web of material to form a trailing end of a downstream sheet and a leading end of an upstream sheet.

In some embodiments of the method, all panels forming each discrete stack of a plurality of zig-zag folded panels are joined to one another along common fold lines disposed between adjacent panels to form a continuous web extending between the leading end and the trailing end. This continuous web is formed by a single one of the sheets.

In some embodiments of the method, cutting the web of material includes guiding the web of material on a knife roll and actuating an anvil to cooperate with a knife of the knife roll to cut the web of material to form the trailing end of the downstream sheet and the leading end of the upstream sheet. In some embodiments, the knife roll is a vacuum roll and the leading end of the upstream sheet is vacuum secured to the outer periphery of the knife roll, at least, after the step of cutting. Further yet, in some embodiments, at least a first folding roll of the pair of counter-rotating folding rolls is a vacuum roll. The leading end of each sheet is vacuum transferred from the knife roll to the first folding roll.

In some embodiments of methods according to the invention, a cutting location between the anvil and knife roll is laterally offset from being vertically positioned above the nip between the pair of counter-rotating folding rolls.

To separate the discrete stacks of panels, in some embodiments of the methods, the methods further include inserting at least one build finger between a last panel of downstream sheet and a first panel of the upstream sheet.

Further, in some embodiments of the method, the web of material is free of cuts, scores, perforations or other manipulations of the material at the fold lines configured to assist in separating the panels adjacent to and sharing the common fold line.

In some embodiments of the method, each sheet forming a discrete stack of a plurality of zig-zag folded panels is not interfolded with a prior or subsequent sheet.

In another method according to an embodiment of the invention, a method of forming a plurality of discrete zig-zag folded stacks of panels of a web of material is provided. The method includes feeding the web of material to a pair of counter-rotating folding rolls of a folding apparatus, the counter-rotating rolls having a nip therebetween. The method includes folding the web of material into a plurality of zig-zag folded panels joined to one another along common fold lines disposed between adjacent panels. The method also includes forming a separation line (which may take the form of a score, a perforation, an indentation or other manipulation of the web of material causing it to be weakened and easier to separate at that location) in the web of material establishing the location of a trailing end of a downstream sheet and an upstream sheet. The separation line is configured such that the downstream and upstream sheets remain interconnected after formation of the separation line. The separation line being formed upstream of the nip between the pair of counter-rotating rolls. The method also includes stacking the plurality of zig-zag folded panels into a stack of zig-zag folded panels. The method also includes separating a discrete stack of a plurality of the zig-zag folded panels from the stack of zig-zag folded panels by disconnecting the downstream sheet from the upstream sheet at the separation line therebetween.

In one embodiment of the method, separating occurs downstream of the counter-rotating folding rolls and occurs by pulling the downstream sheet away from the upstream sheet to cause the downstream sheet to be disconnected from the web of material.

In one embodiment of the method, the separation line is formed between a last fold line of the downstream sheet and a first fold line of the upstream sheet. A last panel of the downstream sheet formed between the last fold line and the trailing end thereof is less than a full panel and a first panel of the upstream sheet formed between the first fold line and the leading end thereof is less than a full panel.

In one embodiment of the method, the separation line formed between the upstream and downstream sheets is formed at a fold line such that the first and last panel of each discrete stack of a plurality of zig-zag folded panels is a full panel.

In one embodiment of the method, separating includes pulling a lower portion of the stack of zig-zag folded panels away from an upper portion of the stack of zig-zag folded panels in such a manner that the web of material breaks at the separation line. The discrete stack of a plurality of the zig-zag folded panels includes the lower portion of the stack of zig-zag folded panels. In further embodiments of the invention, the method further includes inserting a lower portion separator and an upper portion separator between the upper and lower portions of the stack of zig-zag folded panels and wherein the lower portion separator secures a top of the lower portion and the upper portion separator secures a bottom of the upper portion as the lower portion as the lower portion of the stack of zig-zag folded panels is pulled away from the upper portion of the stack of zig-zag folded panels. In another embodiment of the method, the upper portion separator is a first build finger and the lower portion separator is a count finger.

In one embodiment of the method, the method further comprises supporting the lower portion of the stack of zig-zag folded panels with a second build finger and wherein the lower portion is compressed between the second build finger and the count finger as the lower portion of the stack of zig-zag folded panels is pulled away from the upper portion of the stack of zig-zag folded panels.

In one embodiment of the method, the separation line formed between the upstream and downstream sheets is formed at a fold line such that the first and last panel of each discrete stack of a plurality of zig-zag folded panels is a full panel.

In other embodiments of the method, the separation line is formed between a last fold line of the downstream sheet and a first fold line of the upstream sheet. A last panel of the downstream sheet formed between the last fold line and the trailing end thereof is less than a full panel and a first panel of the upstream sheet formed between the first fold line and the leading end thereof is less than a full panel.

In other embodiments of the method, each discrete stack of a plurality of zig-zag folded panels is formed from a single sheet and extends continuously between the leading end and the trailing end, the common fold lines disposed between adjacent panels of the discrete stack being free of separation lines, such as cuts, perforations, scores, etc.

In embodiments of the method, the separation line is a perforation extending transversely across the web of material and generally parallel to the fold lines.

In other embodiments of the method, each sheet forms a discrete stack of a plurality of zig-zag folded panels that is not interfolded with a prior or subsequent sheet.

In a preferred method, each sheet includes at least ten zig-zag folded panels connected at common fold lines interposed between adjacent ones of the panels.

A folding apparatus for forming discrete stacks of a plurality of zig-zag folded panels joined together along common fold lines disposed between adjacent panels from a web of material is provided in one embodiment. Each discrete stack is formed from a single sheet. The folding apparatus includes a pair of counter-rotating folding rolls forming a nip therebetween for passage through the nip of the web of material for zig-zag folding the web of material into the plurality of zig-zag folded panels joined together along common fold lines disposed between adjacent panels. A cutting arrangement is provided upstream of the pair of counter-rotating folding rolls for cutting a sheet from the continuous web of material. A stacking arrangement for stacking the zig-zag folded panels as the panels exit the pair of counter-rotating folding rolls is downstream of the counter-rotating folding rolls.

In some forms, the stacking arrangement is configured to separate the last panel of a downstream sheet forming a first discrete stack of a plurality of zig-zag folded panels from a first panel of an upstream sheet forming a second discrete stack of a plurality of zig-zag folded panels.

In some forms, the stacking arrangement includes first and second build fingers. The first and second build fingers sequentially separating adjacent upstream and downstream sheets forming the discrete stacks of a plurality of zig-zag folded panels. Each sheet being vertically supported by one of the first and second build fingers as each discrete stack of a plurality of zig-zag folded panels is being formed.

In some embodiments, the cutting arrangement includes a knife roll and a cooperating anvil. The cooperating anvil cooperating with at least one knife of the knife roll to cut the sheets from the web of material. In some embodiments, the knife roll and at least one of the pair of counter-rotating folding rolls are vacuum rolls. In this arrangement, the leading end of each sheet can be transferred from the knife roll to the at least one of the pair of counter-rotating folding rolls after a downstream sheet has been cut from the web of material. In other forms one or more intervening lap rolls can be positioned between the knife roll and the folding rolls. The intervening lap rolls preferably are vacuum rolls for vacuum transporting the sheet from the knife roll to the folding roll.

In one embodiment, the cutting arrangement is configured to cut the web of material such that each sheet is sufficiently long to form at least ten interconnected zig-zag folded panels.

In another embodiment, a folding apparatus for forming discrete stacks of a plurality of zig-zag folded panels joined together along common fold lines disposed between adjacent panels from a web of material that does not sever the sheets from the web of material prior to folding the panels is provided. The folding apparatus includes a pair of counter-rotating folding rolls forming a nip therebetween for passage through the nip of the web of material for zig-zag folding the web of material into zig-zag folded panels joined together along common fold lines disposed between adjacent panels to form a stack of zig-zag folded panels. A separation line arrangement upstream of the pair of counter-rotating folding rolls is configured to form a separation line in the web of material defining downstream and upstream sheets. The separation line arrangement is configured such that the separation line does not completely sever the web of material and the downstream and upstream sheets remain interconnected after passing through the separation line arrangement and the counter-rotating folding rolls. A separation arrangement downstream of the counter-rotating folding rolls is configured to operatively separate each sheet from the web of material into a discrete stack of a plurality of zig-zag folded panels at the separation line.

In one embodiment, the separation line arrangement is configured to form separation lines that are perforations extending transverse to a direction of travel of the web of material through the separation line arrangement.

In one embodiment, the separation line arrangement is configured to intermittently operably form the separation line in the web of material such that each sheet defined between adjacent separation lines is sufficiently long to form each sheet into at least ten zig-zag folded panels joined together along common fold lines disposed between adjacent panels.

In another embodiment, the separation line arrangement is configured to form the separation line such that a last panel of the downstream sheet and the first panel of an upstream sheet are each less than a full panel.

In one embodiment, the separation arrangement is configured to pull a lower portion of the stack of zig-zag folded panels away from an upper portion of the stack of zig-zag folded panels in such a manner that the web of material breaks at the separation line. The lower portion of the stack of zig-zag folded panels forms at least a part of the discrete stack of a plurality of zig-zag folded panels formed by the downstream sheet. The upper portion of the stack of zig-zag folded panels forms at least a part of the discrete stack of a plurality of zig-zag folded panels formed by the upstream sheet. In a more particular embodiment, the separation arrangement includes first and second build fingers. The first build finger vertically supports the lower portion of the stack of zig-zag folded panels and the second build fingers vertically supports the upper portion of the stack of zig-zag folded panels. The separation arrangement further includes a count finger. The count finger secures a top section of the bottom portion of the stack of zig-zag folded panels as the upper and lower portions are pulled away from one another.

In one embodiment, the separation line arrangement is configured to form the separation line at the location of a fold line. The last panel of the downstream sheet is formed between a last fold line of the downstream sheet and the separation line is a full pane. The first panel of the upstream sheet formed between a first fold line of the upstream sheet and the separation line is a full panel.

In one embodiment, the count finger and the second build finger are configured to be inserted into a gap formed between the last panel and the first panel. The second build finger secures the first panel and the count finger secures the last panel as the upper and lower portions are pulled away from one another.

In one embodiment, the separation arrangement is configured to pull the lower portion away from the upper portion after a sufficient number of panels of the upper portion have been built-up on the first panel to prevent movement of the first panel relative to the second build finger as the upper and lower portions are pulled away from one another. In an alternative embodiment, the separation arrangement further includes a second count finger. A lower section of panels of the upper portion of panels being compressed between the second count finger and the second build finger to prevent movement of the first panel relative to the second build finger as the upper and lower portions are pulled away from one another.

In one embodiment, the separation line arrangement is configured to form the separation line at a location between consecutive fold lines. The last panel of the downstream sheet is formed between a last fold line of the downstream sheet and the separation line. The first panel of the upstream sheet is formed between a first fold line of the upstream sheet and the separation line. Each of the last panel and the first panel being less than a full panel after the downstream and upstream sheets are separated from one another.

Other aspects, objects and advantages of the invention will be apparent from the following detailed description and accompanying drawings.

### BRIEF DESCRIPTION OF THE DRAWINGS

The accompanying drawings incorporated into and forming a part of the specification illustrate several aspects of the present invention and, together with the description, serve to explain the principles of the invention. In the drawings:

FIG. 1 is a schematic illustration of an exemplary embodiment of a folding apparatus for forming stacks of a plurality of zig-zag folded panels from a single web of material.

FIG. 2 illustrates a stacking operation when the folding apparatus is configured to form first and last panels of the stack of zig-zag folded panels as less than full panels.

FIG. 3 illustrates a stacking operation when the folding apparatus is configured to form first and last panels of the stack of zig-zag folded panels as full panels.

FIG. 4 is a schematic illustration of an exemplary embodiment of a folding apparatus for forming stacks of a plurality of zig-zag folded panels from a single web of material.

FIGS. 5-7 illustrate a separation operation for separating individual sheets from the continuous web of material after a folding operation when the first and last panels of the stack of zig-zag folded panels are a full panel.

FIGS. 8-10 illustrate a separation operation for separating individual sheets from the continuous web of material after a folding operation when the first and last panels of the stack of zig-zag folded panels are less than full panels.

FIG. 11 is a simplified illustration of a zig-zag folded sheet.

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

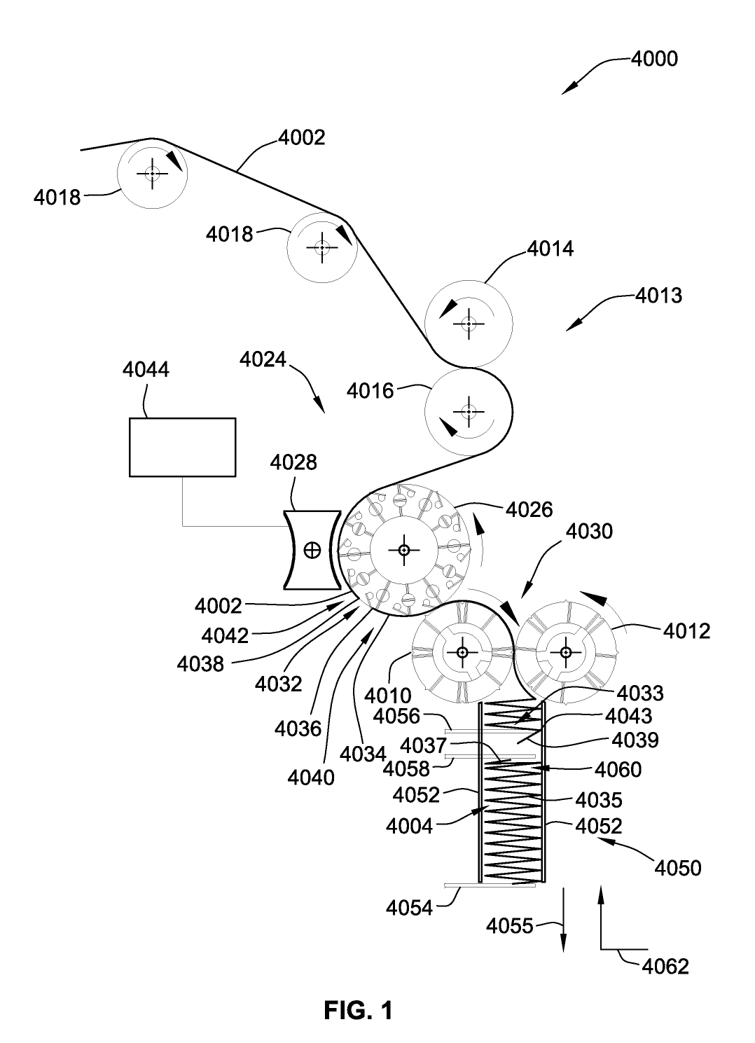

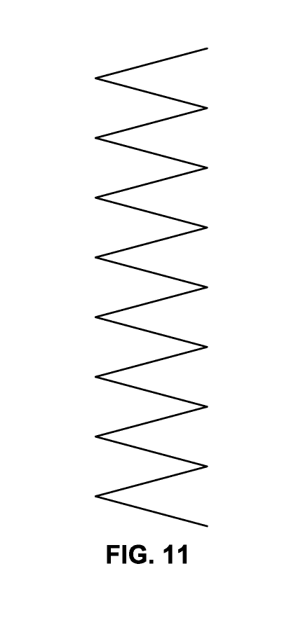

FIG. 1 is a schematic illustration of a first exemplary embodiment of a folding apparatus 4000, according to an embodiment of the invention, which is capable of converting a continuous web of material 4002 into discrete stacks of a plurality of zig-zag folded panels 4004 (individually referred to as a “discrete stack 4004”). Each discrete stack 4004 is formed from a single sheet of material that is a continuous length of the web of material 4002. An individual stack or sheet may also be referred to as a “pack” of the zig-zag folded panels. The single sheet of material has a plurality of panels that are connected with a common fold line between adjacent panels. The discrete stack 4004 has a folded pattern as illustrated in FIG. 11.

Typically, there is no overlapping between successive zig-zag folded sheets, but it will be understood that an apparatus and/or method according to the invention may be utilized to provide some degree of overlap of successive zig-zag folded sheets

Typically, these discrete stacks 4004 find applicability in paper towel dispensers that include an integral cutting mechanism or device for tearing mechanism. This allows the user to determine the desired length of a dispensed paper towel and the user is not confined to the predetermined lengths typically found in a paper towel dispenser having a plurality of interfolded sheets. This arrangement is similar to having a roll of the web of material that must be torn by the user at the paper towel dispenser. Much like the roll of the web of material, all of the panels in the discrete stacks 4004 are formed from a continuous single length of the web of material, i.e. a single sheet.

The discrete stack 4004 will have a generally rectangular cross-section rather than the round roll of web of material. This rectangular cross-section allows for a more efficient use of space in the dispenser. This is particularly true where spare discrete stacks are stored in the dispenser. When multiple rolls are stored in a single dispenser, significant voids are formed between the rolls due to the stacked circular cross-sections. These voids take-up vertical space but do not hold any web of material. However, when rectangular discrete stacks 4004 are used, substantially no voids are formed therebetween.

The folding apparatus 4000 includes a feeding arrangement 4013 in the form of a pair of counter-rotating pull rolls 4014, 4016 and a plurality of upstream guide rolls 4018. The feed arrangement 4013 feeds the upstream continuous web of material 4002 to the counter-rotating folding rolls 4010, 4012.

Downstream from the feed arrangement 4013, the folding apparatus 4000 includes cutting arrangement 4024 in the form of a knife roll 4026 and cooperating anvil 4028. The cutting arrangement 4024 is upstream from the nip 4030 between the pair of counter-rotating folding rolls 4010, 4012. At a count operation, the cutting arrangement severs a discrete sheet from the upstream continuous web of material 4012.

The cutting arrangement 4024 can be configured to move the anvil 4028 toward and away from knife roll 4026 such that the anvil 4028 cooperates with knives of knife roll 4026 to cut the web of material 4002 into sheets having a predetermined length of the web of material, such as sheets 4034 and 4035 illustrated in FIG. 1. Alternatively, the knives of the knife roll 4026 can be actuated relative to the rest of the knife roll 4026 to transition towards anvil 4028 while the anvil 4028 remains stationary. Further yet, other cutting arrangements 4024 for severing sheets from the continuous web of material 4002 can be used.

When the cutting arrangement 4024 cuts the web of material 4002, the cutting arrangement 4024 cuts a sheet that is used to form an entire discrete stack 4004. This is unlike interfolded stacks, where a plurality of sheets are interfolded, by at least one panel, to form a stack of panels from a plurality of short lengths of material (i.e. each length provides an individual sheet).

Preferably, consecutively formed discrete stacks 4004 never have any panels thereof interfolded during the forming process.

In a preferred implementation, each discrete stack 4004 includes at least ten (10) zig-zag folded panels. A common fold line connects adjacent panels. While illustrated in an expanded accordion style in FIG. 11, in practice, the panels would be compressed such that substantially no gaps or voids are formed therebetween.

In FIG. 1, the cutting arrangement 4024 has just performed a cutting operation on the web of material 4002. A cut line 4032 is formed between the continuously supplied web of material 4002 and sheet 4034. The cut line 4032 forms the trailing end 4036 of sheet 4034 and the leading end 4038 of the continuous web of material 4002. This leading end 4038 will also be the leading end of the next sheet that is to be formed from the continuous web of material 4002 after the next cutting operation.

In the illustrated embodiment, the knife roll 4026 and at least folding roll 4010 include cooperatively controlled gripping and sheet handling devices, in the form of mechanical grippers, or vacuum ports, or some combination of these features or the like. These features are well-known in the art and are not specifically illustrated herein. It is further well-known in the art to control the application and removal of vacuum, the angular positions of actuation and release of mechanical grippers, and the application of blasts of air or positioning of other guiding devices or elements to cause a sheet passing through a folding apparatus to transfer in a desired manner between adjacent rolls.

Preferably, the rolls are vacuum rolls configured to selectively vacuum attach the web of material to the outer peripheries thereof. The use of the vacuum rolls allows the folding apparatus 4000 to retain control of the trailing end portion 4040 of sheet 4034 and the leading end portion 4042 of the continuous web of material 4002 after the sheet 4034 has been cut from the continuous web of material 4002. The leading end portion 4042 of the continuous web of material 4002 can be transferred to the outer periphery of folding roll 4010 using standard known vacuum transfer techniques.

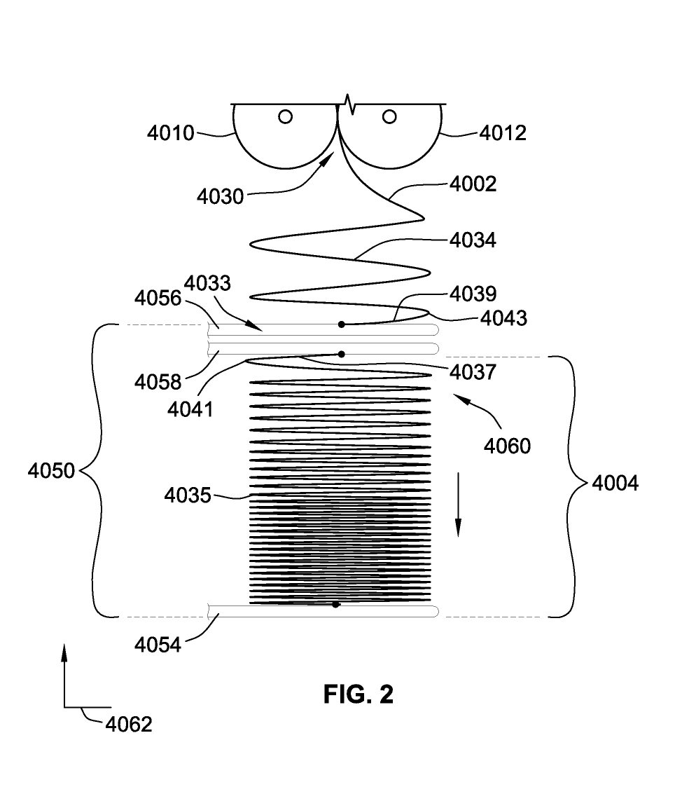

A further cut line 4033 is illustrated downstream of the counter-rotating folding rolls 4010, 4012 in FIG. 1. This cut line 4033 is formed between sheet 4034, which is currently being folded, and a downstream sheet 4035 from which a first discrete stack 4004 is formed. With reference to FIG. 2, a last panel 4037 of downstream sheet 4035 and a first panel 4039 of upstream sheet 4034 are formed by the cut line 4033 formed therebetween. The last panel 4037 is formed between the last fold line 4041 of sheet 4035 and the cut line 4033 while the first panel 4039 is formed between the first fold line 4043 of sheet 4034 and cut line 4033. These two panels 4039, 4037 are only partial panels in this embodiment as they do not extend the entire distance between sequential fold lines.

Typical discrete stacks 4004 may have in excess of 100 panels. Thus, a typical sheet may have a length of at least about 300 and 500 inches between a leading end and trailing end thereof if using 3 to 5 inch panel sizes. The length could be longer if using greater panel sizes. For instance, the panel size may be 12 inches or greater. Other embodiments may include in excess of 500 panels dependent on the thickness of the web material and total height of the stack. In such embodiments, the length would be much longer.

In some embodiments, a cam arrangement is used for controlling initiation of a cutting operation. Referring back to FIG. 1, the illustrated embodiment, however, includes a controller 4044 coupled to the cutting arrangement 4024 to initiate the cutting operation. The inclusion of a programmable controller is particularly beneficial because the cutting operation can occur at a relatively infrequent rate as compared to folding apparatuses that form sheets that only have between about two and five panels. More particularly, the knife roll 4026 may complete numerous complete rotations between individual cutting operations such that a mechanical camming arrangement would be difficult to configure. Further, the use of a controller 4044 allows for easy adjustment in the timing of the cutting operation so as to adjust the length of a sheet, i.e. the number of panels in each discrete stack 4004.

The folding apparatus 4000 includes a stacking arrangement 4050 downstream from the pair of counter-rotating folding rolls 4010, 4012. The stacking arrangement 4050 receives the plurality of zig-zag folded panels as the panels exit the pair of counter-rotating folding rolls 4010, 4012. The stacking arrangement 4050 of the illustrated embodiment is a vertically oriented configuration. However, other embodiments could dispense the zig-zag folded panels in a horizontal orientation, with the stack resting on a side thereof defined by the folds between adjacent panels. Typically, the folding apparatus 4000 will include a table on which the stacks will slide as they progress along a folding direction as they exit the folding rolls 4010, 4012.

The stacking arrangement 4050 may include vertical guides 4052 to maintain the folded panels in an organized stack of a plurality of zig-zag folded panels as the panels exit the pair of counter-rotating folding rolls 4010, 4012. The guides 4052 could be stationary guides or movable guides such as moving guides such as rotating screw guides or band style guides.

The stacking arrangement 4050 also includes a plurality of separators for separating the discrete stacks 4004 from the panels of an upstream sheet that may or may not be completely folded. For instance, as illustrated in FIGS. 1 and 2, only a single discrete stack 4004 is illustrated while the upstream sheet 4034 is still being folded. The separators can thus be used to separate sheet 4035 from sheet 4034 to allow for further downstream processing, such as wrapping or banding of the stack 4004.

The separators in the illustrated embodiment include first and second build fingers 4054, 4056, respectively, and a count finger 4058. The build fingers 4054, 4056 extend through the guides 4052 and vertically support the panels as the panels exit the pair of counter-rotating folding rolls 4010, 4012. Typically, the build fingers 4054, 4056 will travel away from the counter-rotating folding rolls 4010, 4012 (i.e. vertically downward as illustrated by arrow 4055) as a stack of panels is “built” (i.e. accumulated) above a corresponding one of the build fingers 4054, 4056.

At some point, the first build finger 4054 will travel vertically downward at a faster rate than second build finger 4056 to separate the discrete stack 4004 from the upstream sheet 4034 as the panels being formed therefrom accumulate into another discrete stack. This process of pulling the discrete stack 4004 away from the upstream sheet 4034 can occur by having the downstream first build finger 4054 travel at a faster rate than the upstream second build finger 4056.

Count finger 4058 can be used to secure a top section 4060 of discrete stack 4004 as the discrete stack 4004 is pulled away from the panels of upstream sheet 4034. To secure top section 4060, the count finger 4058 can compress the panels of discrete stack 4004 against first build finger 4054 as the discrete stack 4004 is pulled away.

In some implementations, the second build finger 4056 and the count finger 4058 are substantially vertically aligned with one another and laterally inserted between the last panel 4037 and the first panel 4039 at the same time. Once inserted, the count finger 4058 will move vertically downward at a faster rate than second build finger 4056 so as to compress the discrete stack 4004 as mentioned above and to remove the discrete stack 4004 from the stacking arrangement 4050.

After the discrete stack 4004 is removed from first build finger 4054, the first build finger 4054 will move laterally outward so not to interfere with the currently building stack as it moves vertically upward, illustrated by bent arrow 4062. The first build finger 4054 can then be used to separate sheet 4034 from the next sheet, i.e. the portion of the web of material upstream from cut line 4032. The first build finger 4054 will then be used to support the next discrete stack that is formed after the stack formed from sheet 4034.

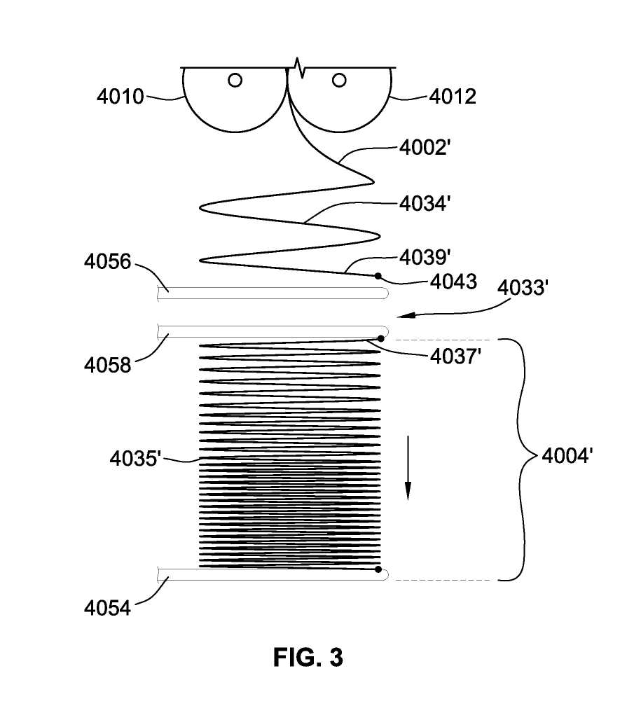

With additional reference to FIG. 3, the folding apparatus 4000 of FIG. 1 can also be configured such that the last panel 4037′ of a downstream sheet 4035′ forming the discrete stack 4004′ and the first panel 4039′ of an upstream sheet 4034′ are formed as full panels. In this configuration, the cutting arrangement 4024, and particularly controller 4044 if provided, can be configured to form the cut lines 4032′, 4033′ at the location of a fold line. The stacking arrangement 4050 (illustrated in FIG. 1) will operate in substantially the same manner as identified above.

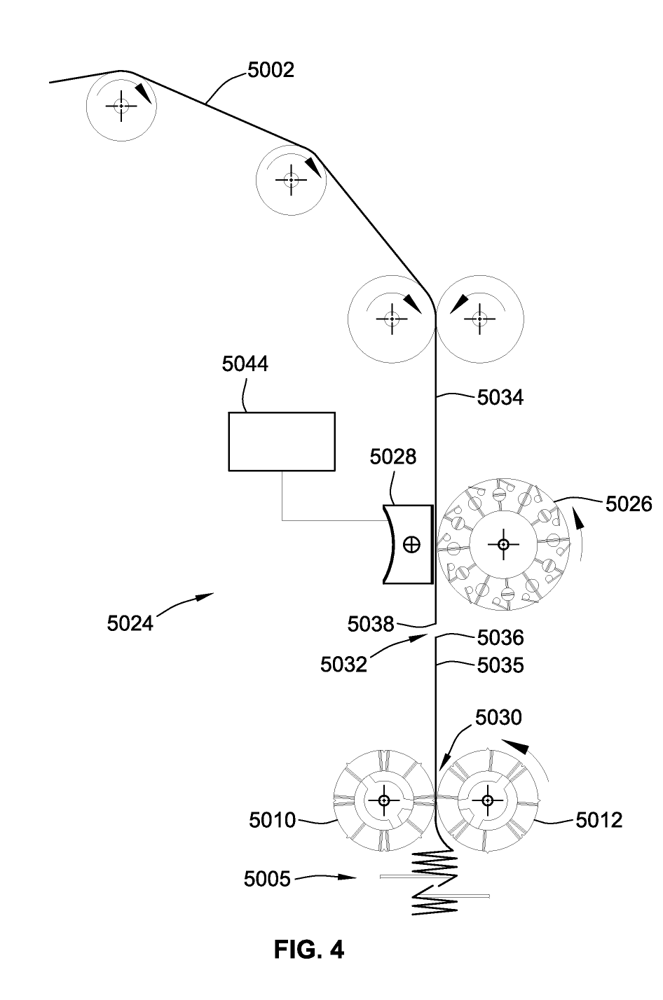

FIG. 4 illustrates a further embodiment of a folding apparatus 5000 according to an embodiment of the invention. This folding apparatus 5000 is again beneficially used to form discrete stacks of a plurality of zig-zag folded panels of a web of material. As such, all of the panels of a discrete stack are formed from a single sheet and adjacent panels are connected with a common fold line therebetween. Consecutively formed sheets, preferably, do not have interfolded panels after passing through folding rolls 5010, 5012 of folding apparatus 5000.

Folding apparatus 5000 does not separate a sheet 5034 from the web of material 5002 until the entire sheet 5034 has passed through nip 5030 between the counter-rotating folding rolls 5010, 5012. As such a preferred implementation of folding apparatus 5000 does not require vacuum rolls. This is because the web of material 5002 remains substantially continuous at all times upstream of the pair of counter-rotating folding rolls 5010, 5012.

Rather than including a cutting arrangement, as in the embodiment of FIG. 1, the folding apparatus 5000 includes a separation line arrangement 5024 that forms a separation line 5032 in the web of material 5002 upstream of the counter-rotating folding rolls 5010, 5012. While separation line 5032 is illustrated as a complete break in the line representing the web of material 5002, the separation line 5032 is not a break in the web of material. The separation line 5032 does not completely sever the downstream sheet 5035 from the rest of the web of material 5002 that is upstream therefrom. Instead, the separation line forms a weakened portion of the web of material 5002 that serves as a tear or separation concentration location for subsequent downstream separation downstream from the folding rolls 5010, 5012.

The separation line arrangement 5024 generally includes a knife roll 5026, an anvil 5028 and a controller 5044. Again, the anvil 5028 can be actuated toward or away from the knife roll 5026 or alternatively knives of the knife roll 5026 can be actuated into cooperation with a stationary anvil to form the separation line 5032. In this embodiment, the knife of the knife roll 5026 is not a continuous blade but is instead a blade configured to form a separation line 5032 that is one of a perforation, score or other weakened portion of the web of material 5002. Typically, the separation line 5032 will be in the form of a perforation.

The separation line 5032 will establish a trailing end 5036 of the sheet 5035 downstream thereof and a leading end 5038 of the upstream sheet 5034 upstream thereof. However, these ends 5036, 5038 are not actually formed until after passing through the pair of counter-rotating folding rolls 5010, 5012. This is because, as noted above, the separation line 5032 does not completely sever the web of material 5002 and the downstream and upstream sheets adjacent the separation line 5032 remain interconnected after the formation of the separation line 5032. This separation line 5032 is formed upstream of the nip 5030 between the pair of counter-rotating folding rolls 5010, 5012.

The folding apparatus 5000 includes a stacking and separation arrangement 5050 downstream of the pair of counter-rotating folding rolls 5010, 5012 for stacking the panels of the web of material after passing through the counter-rotating folding rolls 5010, 5012. The plurality of panels are stacked into a stack of zig-zag folded panels. Again, the stacking arrangement 5050 may include guides (not illustrated) similar to those discussed with regard to folding apparatus 4000.

The stacking and separation arrangement 5050 is also configured to separate adjacent sheets, i.e. sheets 5034, 5035 in FIG. 4. This separation forms the discrete stack of a plurality of zig-zag folded panels 5004 from the larger stack of zig-zag folded panels by disconnecting the downstream sheet 5035 from the web of material 5002 and particularly from the adjacent upstream sheet 5034 at the separation line 5032 therebetween.

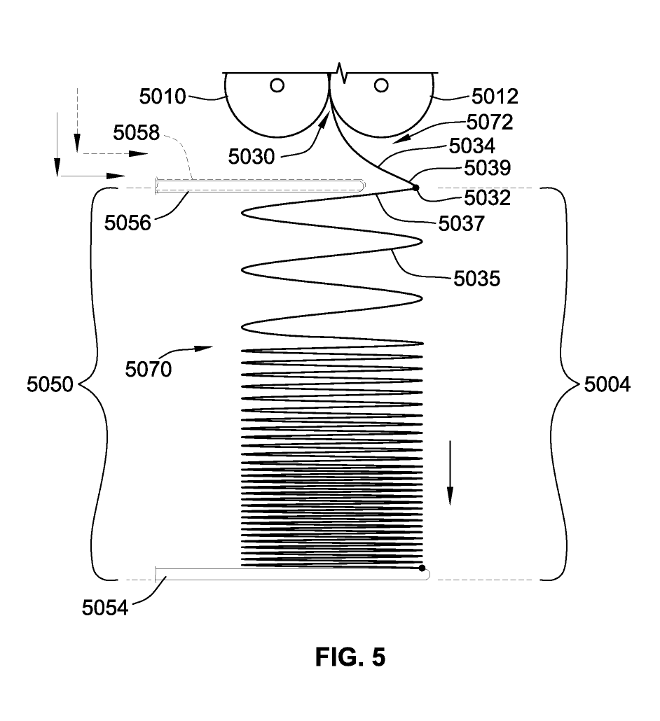

In one configuration, the controller 5044 of the separation line arrangement 5024 is configured to form separation line 5032 at a fold line between adjacent panels. This configuration is illustrated in FIG. 5.

With continued reference to FIG. 5, the stacking and separation arrangement 5050 includes first and second build fingers 5054, 5056 upon which panels are accumulated to form the discrete stacks of zig-zag folded panels 5004. The first and second build fingers 5054, 5056 vertically support the sheets 5034, 5035 as the zig-zag folded panels thereof exit the nip 5030 between the counter-rotating folding rolls 5010, 5012.

The stacking and separation arrangement 5050 also includes at least one count finger 5058 (illustrated in dashed lines in FIG. 5). The folding apparatus 5000 is configured to form first and last panels 5039, 5037 of each discrete stack 5004 as full panels. As such, in this configuration, the separation line arrangement 5024 forms a separation line at a location along the web of material 5002 that coincides with a fold line. In this configuration, the web of material is actually folded at the separation lines as the web of material 5002 passes through nip 5030.

The stacking and separation arrangement 5050 performs the step of separating the sheets 5034, 5035 from one another. More particularly, the stacking and separation arrangement 5050 pulls a lower portion 5070 of the stack of the plurality of zig-zag folded panels away from an upper portion 5072 of the stack of zig-zag folded panels. This processes of pulling the two portions 5070, 5072 away from one another creates tension at the separation line 5032 causing the web of material 5002 to break at that location. Once the web of material 5002 breaks at the separation line 5032, a discrete stack of a plurality of zig-zag folded panels 5004 is formed. Just like the discrete stacks of the prior folding apparatus 4000, the panels of adjacent discrete stacks 5004 are never inter-folded.

When it is desired to separate adjacent sheets 5034, 5035, second build finger 5056 and count finger 5058 are laterally transitioned laterally into the void formed between last panel 5037 and first panel 5039. Preferably, the build finger 5056 and the count finger 5058 are at substantially a same axial position along the path at which the folded sheets travel as they exit the folding rolls.

After insertion between the last and first panels 5037, 5039, count finger 5058 will transition away from the second build finger 5056 by traveling at a faster vertically downward direction than second build finger 5056.

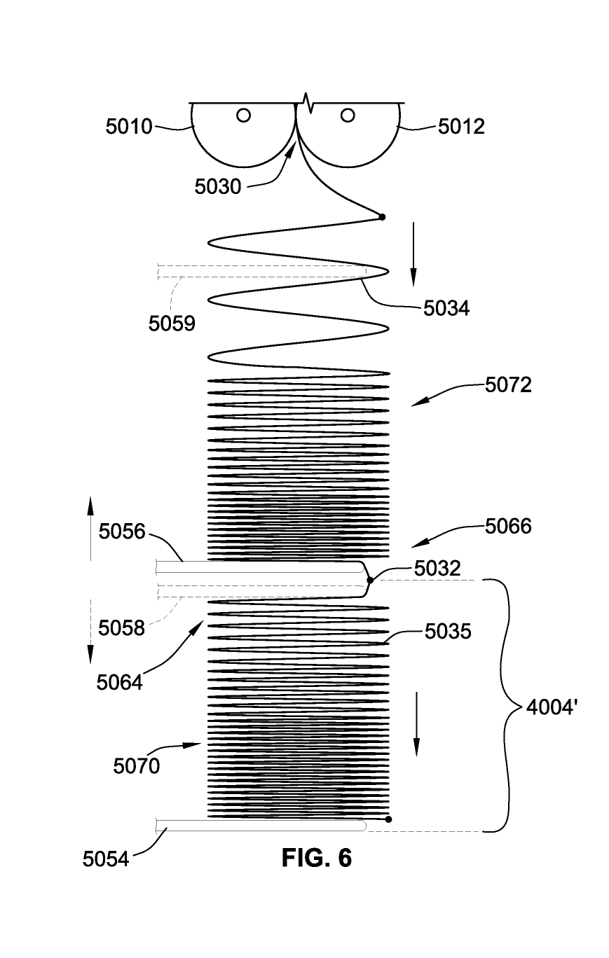

With reference to FIG. 6, count finger 5058 secures a top section 5064 of the bottom portion 5070 of the stack of zig-zag folded panels while second build finger 5056 secures a bottom section 5066 of the upper portion 5072 of the stack of zig-zag folded panels as the two portions 5070, 5072 are pulled away from one another to perform the separation process.

In one implementation, the separation process occurs after a sufficient number of zig-zag folded panels have been deposited onto the first panel 5039 to provide enough weight thereon to secure the position of the first panel 5039 against second build finger 5056 during the separation process. This implementation is illustrated in FIG. 6.

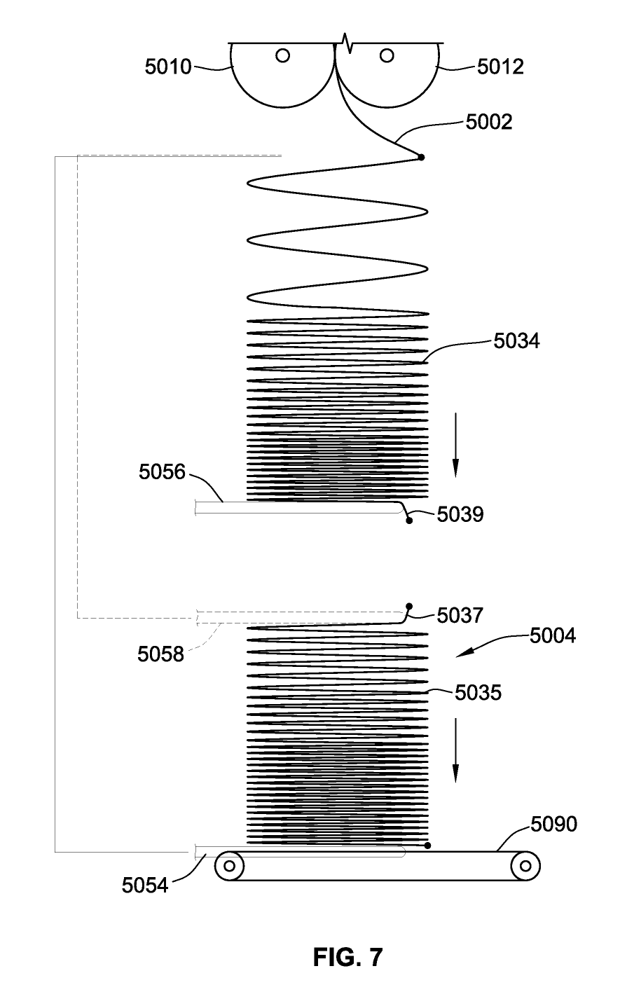

During the separation process, the top section 5064, under control of count finger 5058, is moved away from second build finger 5056 to cause the web of material 5002 to break at separation line 5032 formed between the adjacent sheets 5034, 5035. This is illustrated in FIG. 7.

In an alternative implementation, a second count finger 5059 (illustrated in dashed lines in FIG. 6) can be used to assist in securing the bottom section 5066 of the upper portion 5072 of the stack of zig-zag folded panels. The second count finger 5059 acts to compress the upper portion 5072 of the stack of zig-zag folded panels against the second build finger 5056. This provides a positive securement of the first panel 5039 of the upstream sheet 5034 during the separation process.

FIG. 7 illustrates the process after the web of material 5002 has been broken at the separation line 5032 thereby separating the downstream sheet 5035 from the adjacent upstream sheet 5034, i.e. after the lower portion 5070 of the stack of zig-zag folded panels has been pulled sufficiently far away from the upper portion 5070 of the stack of zig-zag folded panels.

Once the discrete stack of a plurality of zig-zag folded panels 5004 is removed from first build finger 5054, such as by being loaded on to conveyor 5090, the first build finger 5054 and the count finger 5058 recycles back toward the pair of counter-rotating folding rolls 5010, 5012 to repeat the cycle. At such a time, the sheet 5034 will then be separated from the web of material 5002 using the same process.

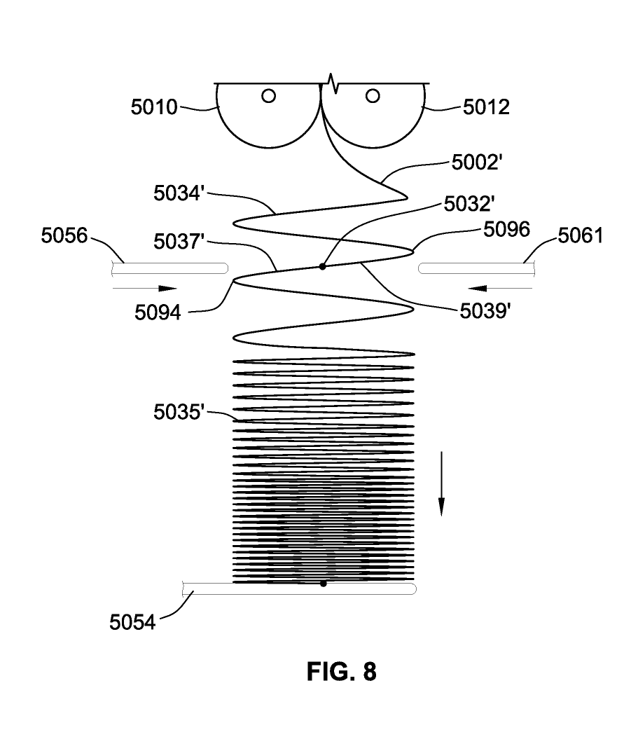

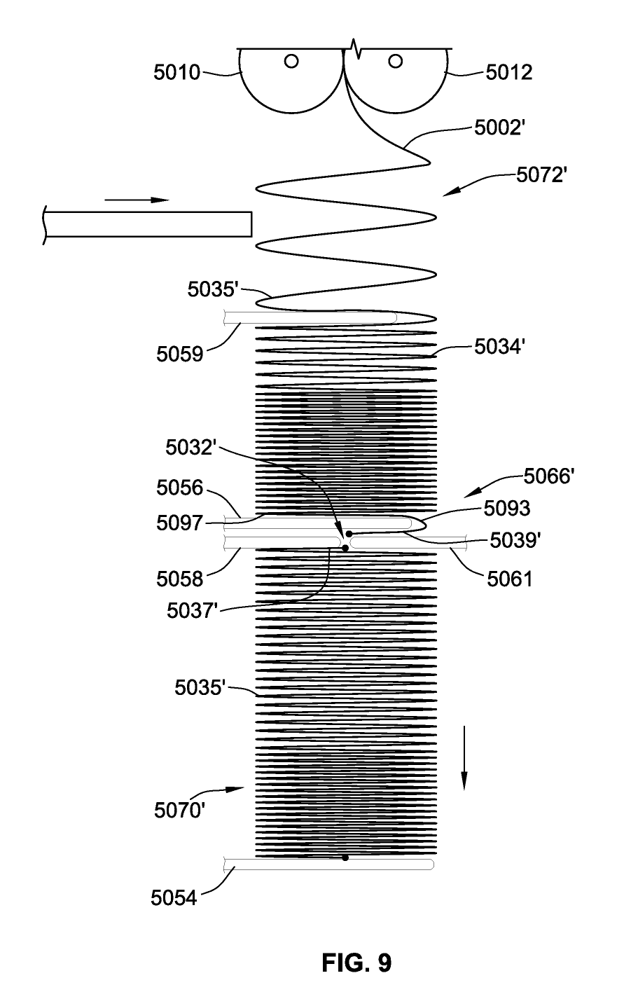

FIGS. 8 and 9 illustrate the separation process when the folding apparatus 5000 is configured to form the separation line 5032′ between adjacent fold lines 5094, 5096 and not at a fold line, as in the prior configuration. In this configuration, the last panel 5037′ and first panel 5039′ of the downstream and upstream sheets 5035′, 5034′, respectively, are less than full panels.

As illustrated in FIG. 8, the first build finger 5054 vertically supports the stack of a plurality of zig-zag folded panels as the panels are being folded by and dispensed from the pair of counter-rotating folding rolls 5010, 5012. The second build finger 5056 and the count finger 5058 are vertically positioned vertically above the separation line 5032′ and laterally offset from the stack of a plurality of zig-zag folded panels. At this point, sheet 5035′ is still connected to the web of material 5002′.

In FIG. 9, the second build finger 5056 and the count finger 5058 have been transitioned laterally inward into the void 5097 formed between the panel that will form the last and first panels 5037′, 5039′ after the separation process and the second panel 5093 of the upstream sheet 5034. Additionally, count finger 5058 has compressed the panels of the sheet 5035′ against first build finger 5054 to secure last panel 5037′.

At this time, the lower portion 5070′ of the stack of plurality of zig-zag folded panels can be transitioned away from the upper portion 5072′ of the stack of plurality of zig-zag folded panels to break the web of material 5002′ at separation line 5032′ as discussed previously.

However, it may be preferred to include a second count finger 5059 that is inserted into the stack of the plurality of zig-zag folded panels and compresses the panels of the upstream sheet 5034′ against the second count finger 5056 to secure the bottom section 5066′ of the upper portion 5072′.

In this embodiment, an optional third count finger 5061 is used to pinch the first panel 5039′ against second build finger 5056 to further secure the first panel 5039′ during the separation process as the adjacent sheets 5034′, 5035′ are pulled apart from one another.

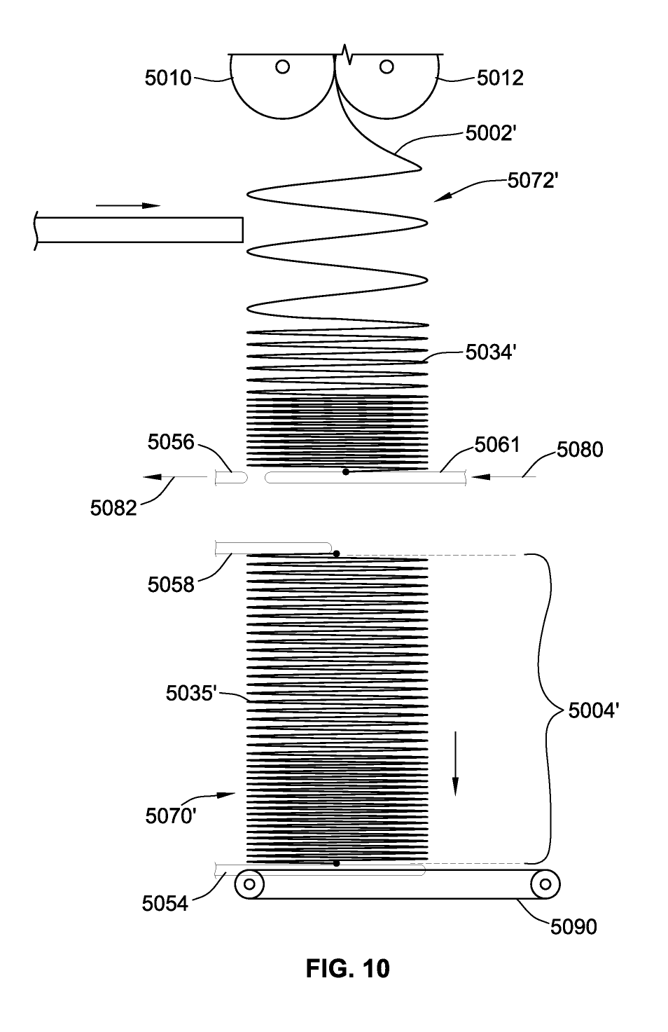

FIG. 10 illustrates the downstream sheet 5035′ broken from the web of material 5002 forming the discrete stack of a plurality of zig-zag folded panels 5004′.

In this embodiment, the optional third count finger 5061 is also used to vertically support the length of the web of material 5034′ after separation. To do this, the third count finger 5061 is transitioned laterally inward to support the sheet 5034′ while the second build finger 5056 is translated laterally outward as illustrated by arrows 5080, 5082.

Further, embodiments that separate two sheets between adjacent fold lines as illustrated in FIGS. 9 and 10 could utilize at least one build finger and at least one count finger on each side of the stack of plurality of zig-zag folded panels. With such an arrangement, alternating stacks of folded panels will be supported from alternating sides.

In the embodiments illustrated in FIGS. 1-10, the web of material 4002, 5002 is not manipulated at each fold line. As such, a cutting operation or formation of a separation line only occurs once per length of the web of material, i.e. once per count.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for forming a single sheet of a web of material into a zig-zag folded stack of panels of the web of material comprising:
feeding the web of material to a pair of counter-rotating folding rolls of a folding apparatus, the counter-rotating rolls having a nip therebetween;
folding the web of material into a plurality of interconnected zig-zag folded panels;
separating the web of material into sheets upstream of the nip between the pair of counter-rotating rolls; and
forming each sheet into a discrete stack of a plurality of zig-zag folded panels.

2. The method of claim 1, wherein separating the web of material into sheets includes cutting the web of material to form a trailing end of a downstream sheet and a leading end of an upstream sheet.

3. The method of claim 2, wherein all panels forming each discrete stack of a plurality of zig-zag folded panels are joined to one another along common fold lines disposed between adjacent panels to form a continuous sheet extending between the leading end and the trailing end.

4. The method of claim 2, wherein cutting the web of material includes guiding the web of material on a knife roll and actuating an anvil to cooperate with a knife of the knife roll to cut the web of material to form the trailing end of the downstream sheet and the leading end of the upstream sheet.

5. The method of claim 4, wherein:
the knife roll is a vacuum roll and the leading end of the upstream sheet is vacuum secured to the outer periphery of the knife roll, at least, after the step of cutting at least a first folding roll of the pair of counter-rotating folding rolls is a vacuum roll and wherein the leading end the sheet is vacuum transferred from the knife roll to the first folding roll.

6. The method of claim 5, wherein a cutting location between the anvil and knife roll is laterally offset from being vertically positioned above the nip between the pair of counter-rotating folding rolls.

7. The method of claim 3, wherein the continuous sheet is free of manipulations at the fold lines.

8. The method of claim 1, wherein each sheet forming a discrete stack of a plurality of zig-zag folded panels is not interfolded with a prior or subsequent sheet.

9. A method of forming a plurality of discrete zig-zag folded stacks of panels of a web of material comprising:
feeding the web of material to a pair of counter-rotating folding rolls of a folding apparatus, the counter-rotating rolls having a nip therebetween;
folding the web of material into a plurality of zig-zag folded panels joined to one another along common fold lines disposed between adjacent panels;
forming a separation line in the web of material establishing the location of a trailing end of a downstream sheet and an upstream sheet, the downstream and upstream sheets remaining interconnected after formation of the separation line, the separation line being formed upstream of the nip between the pair of counter-rotating rolls;
stacking the plurality of zig-zag folded panels into a stack of zig-zag folded panels; and
separating a discrete stack of a plurality of the zig-zag folded panels from the stack of zig-zag folded panels by disconnecting the downstream sheet from the upstream sheet at the separation line therebetween.

10. The method of claim 9, wherein separating occurs downstream of the counter-rotating folding rolls.

11. The method of claim 11, wherein the separation line is formed between a last fold line of the downstream sheet and a first fold line of the upstream sheet, wherein a last panel of the downstream sheet formed between the last fold line and the trailing end thereof is less than a full panel and a first panel of the upstream sheet formed between the first fold line and the leading end thereof is less than a full panel.

12. The method of claim 9, wherein the separation line formed between the upstream and downstream sheets is formed at a fold line such that the first and last panel of each discrete stack of a plurality of zig-zag folded panels is a full panel.

13. The method of claim 9, wherein separating includes pulling a lower portion of the stack of zig-zag folded panels away from an upper portion of the stack of zig-zag folded panels in such a manner that the web of material breaks at the separation line, the discrete stack of a plurality of the zig-zag folded panels including the lower portion of the stack of zig-zag folded panels.

14. The method of claim 13, further comprising inserting a lower portion separator and an upper portion separator between the upper and lower portions of the stack of zig-zag folded panels and wherein the lower portion separator secures a top of the lower portion and the upper portion separator secures a bottom of the upper portion as the lower portion of the stack of zig-zag folded panels is pulled away from the upper portion of the stack of zig-zag folded panels.

15. The method of claim 14, wherein the upper portion separator is a first build finger and the lower portion separator is a count finger; and
further comprising supporting the lower portion of the stack of zig-zag folded panels with a second build finger and wherein the lower portion is compressed between the second build finger and the count finger as the lower portion of the stack of zig-zag folded panels is pulled away from the upper portion of the stack of zig-zag folded panels.

16. The method of claim 9, wherein each discrete stack of a plurality of zig-zag folded panels is formed from a single sheet and extends continuously between the leading end and the trailing end, the common fold lines disposed between adjacent panels being free of separation lines.

17. The method of claim 9, wherein the separation line is a perforation extending transversely across the web of material and generally parallel to the fold lines.

18. The method of claim 9, wherein each sheet forming a discrete stack of a plurality of zig-zag folded panels is not interfolded with a prior or subsequent sheet.

19. A folding apparatus for forming discrete stacks of a plurality of zig-zag folded panels joined together along common fold lines disposed between adjacent panels from a web of material, each discrete stack formed from a single sheet formed from a continuous web of material, the folding apparatus comprising:
a pair of counter-rotating folding rolls forming a nip therebetween for zig-zag folding the web of material into the plurality of zig-zag folded panels joined together along common fold lines disposed between adjacent panels;
a cutting arrangement upstream of the pair of counter-rotating folding rolls for cutting a sheet from the web of material,
a stacking arrangement for stacking the zig-zag folded panels as the panels exit the pair of counter-rotating folding rolls.

20. The folding apparatus of claim 24, wherein the stacking arrangement is configured to separate the last panel of a downstream sheet forming a first discrete stack of a plurality of zig-zag folded panels from a first panel of an upstream sheet forming a second discrete stack of a plurality of zig-zag folded panels.

21. The folding apparatus of claim 19, wherein the cutting arrangement includes a knife roll and a cooperating anvil, the cooperating anvil cooperating with at least one knife of the knife roll to cut the sheets from the continuous web of material.

22. The folding apparatus of claim 21, wherein the knife roll and at least one of the pair of counter-rotating folding rolls are vacuum rolls, such that the leading end of each sheet can be transferred from the knife roll to the at least one of the pair of counter-rotating folding rolls after a downstream sheet has been cut from the continuous web of material.

23. The folding apparatus of claim 19, wherein the cutting arrangement is configured to cut the continuous web of material such that each sheet is sufficiently long to form at least twenty-five interconnected panels.

24. A folding apparatus for forming discrete stacks of a plurality of zig-zag folded panels joined together along common fold lines disposed between adjacent panels from a web of material, the folding apparatus comprising:
a pair of counter-rotating folding rolls forming a nip therebetween for zig-zag folding the web of material into zig-zag folded panels joined together along common fold lines disposed between adjacent panels to form a stack of zig-zag folded panels;
a separation line arrangement upstream of the pair of counter-rotating folding rolls configured to form a separation line in the web of material defining downstream and upstream sheets, the separation line arrangement configured such that the separation line does not completely sever the web of material and the downstream and upstream sheets remain interconnected after passing through the separation line arrangement;
a separation arrangement downstream of the counter-rotating folding rolls configured to operatively separate each sheet from the web of material into a discrete stack of a plurality of zig-zag folded panels at the separation line.

25. The folding apparatus of claim 24, wherein the separation line arrangement is configured to form separation lines that are perforations extending transverse to a direction of travel of the web of material through the separation line arrangement.

26. The folding apparatus of claim 24, wherein the separation line arrangement is configured to intermittently operably form the separation line in the web of material such that each sheet defined between adjacent separation lines is sufficiently long to form each sheet into at least twenty-five zig-zag folded panels joined together along common fold lines disposed between adjacent panels.

27. The folding apparatus of claim 24, wherein the separation arrangement is configured to pull a lower portion of the stack of zig-zag folded panels away from an upper portion of the stack of zig-zag folded panels in such a manner that the web of material breaks at the separation line, the lower portion of the stack of zig-zag folded panels forming at least a part of the discrete stack of a plurality of zig-zag folded panels formed by the downstream sheet, the upper portion of the stack of zig-zag folded panels forming at least a part of the discrete stack of a plurality of zig-zag folded panels formed by the upstream sheet.

28. The folding apparatus of claim 27, wherein the separation arrangement includes first and second build fingers the first build finger vertically supporting the lower portion of the stack of zig-zag folded panels and the second build fingers vertically supporting the upper portion of the stack of zig-zag folded panels, the separation arrangement further including a count finger, the count finger securing a top section of the bottom portion of the stack of zig-zag folded panels as the upper and lower portions are pulled away from one another.

29. The folding apparatus of claim 28, wherein the separation line arrangement is configured to form the separation line at the location of a separation fold line, a last panel of the downstream sheet formed between a last fold line of the downstream sheet and the separation line is a full panel and a first panel of the upstream sheet formed between a first fold line of the upstream sheet and the separation line is a full panel.

30. The folding apparatus of claim 29, wherein the count finger and the second build finger are configured to be inserted into a gap formed between the last panel and the first panel, the second build finger securing the first panel and the count finger securing the last panel as the upper and lower portions are pulled away from one another.

31. The folding apparatus of claim 30, wherein the separation arrangement is configured to pull the lower portion away from the upper portion after a sufficient number of panels of the upper portion have been built-up on the first panel to prevent movement of the first panel relative to the second build finger as the upper and lower portions are pulled away from one another.

32. The folding apparatus of claim 30, further including a second count finger, a lower section of panels of the upper portion of panels being compressed between the second count finger and the second build finger to prevent movement of the first panel relative to the second build finger as the upper and lower portions are pulled away from one another.
